(19) United States
(12) Patent Application Publication
(10) Pub. No.: US 2023/0294927 A1
(43) Pub. Date: Sep. 21, 2023

(54) A SPROCKET WHEEL FOR DRIVING AN EDGE DRIVEN BELT CONVEYOR

(71) Applicant: GEA REFRIGERATION CANADA INC., Vancouver (CA)

(72) Inventors: That NGUYEN, Surrey (CA); Douglas CAMPBELL, Richmond (CA); Esteban SOTO, Richmond (CA)

(73) Assignee: GEA REFRIGERATION CANADA INC., Vancouver, BC (CA)

(21) Appl. No.: 18/013,706

(22) PCT Filed: Jul. 3, 2020
(86) PCT No.: PCT/IB2020/056294

§ 371 Date: Dec. 29, 2022

(51) Int. Cl. B65G 23/06; B65G 21/18

(52) U.S. Cl. CPC B65G 23/06; B65G 21/18; B65G 2207/24; B65G 2201/0202

(57) ABSTRACT

A sprocket wheel for driving an edge driven helical belt conveyor in a food handling facility, such as a freezing facility, comprising at least one integral body with a curved wheel rim part, said curved wheel rim part comprising at least two parallel rows of teeth; and a hub for carrying the integral body and for providing for attachment to a shaft.

### CROSS REFERENCE TO RELATED APPLICATION

The instant application is a U.S. National Stage application of and claims priority to PCT/IB2020/056294, filed on Jul. 3, 2020, the subject matter of this application is hereby incorporated by reference in its entirety.

### TECHNICAL FIELD

The present invention is directed to a sprocket wheel for driving an edge driven belt conveyor such as a helical belt conveyors in a food handling facility in a freezing facility; a freezing room helical belt conveyor sprocket drive; and a freezing facility edge driven helical belt conveyor; and a sprocket wheel having two parallel rows of teeth; and a hub for providing for attachment to a shaft.

### BACKGROUND

In general, edge driven belt conveyors and sprocket wheels are currently being applied in the food handling industry for e.g. helical conveyors in freezing, cooling, cooking, and/or drying facilities.

Sprocket wheels suitable for driving an edge driven helical belt conveyor are as such known in the art, see e.g. EP 3 257 793 A1 (Frans Bakker Beheer (Twentebelt)), which discloses an embodiment in which two separate sprocket wheels are positioned as to provide two parallel rows of teeth. EP 3 257 793 A1 is silent regarding any details of the construction of the sprocket wheel. The provision of two parallel rows of teeth provides for a distance between the two teeth rows suitable for guiding the conveyor belt. This is due to the fact that the conveyor belt side are provided with protrusions extending laterally from the outer side of the belt in between the teeth of the two rows to be guided therein.

Another example of an edge driven belt conveyor with two separate parallel sprockets are found in DE 10 2014 118 022 A1 (Märtens Transportbänder GmbH).

### SUMMARY

There is disclosed herein conveyors in food processing facilities, such as food freezing facilities.

The present inventors the inventive conveyors disclosed herein have utility in addressing hygiene issues relating to sprocket wheels of edge driven helical belt conveyors in food handling facilities in the form of an excessive amount of debris (such as plastic scraps) from excessive wear of the sprocket teeth, and in the form of sprocket wheels being hard to clean thoroughly due to deposits like food particle deposits getting stuck in cracks, crevices, or joints between parts of an assembled sprocket wheel, in particular the exposed cracks, crevices, and joints between parts exposed more during use. This may pose a problem to prior art sprockets if intended for use in a food handling facility, because deposits present in the cracks, crevices, or joints may not be thoroughly cleaned during and after cleaning operations to standards required for food handling. Such standards are e.g. the requirements of applicable 3-A Sanitary Standards (US) and/or applicable EHEDG guidelines (EU), such as DOC 8, Hygienic Design Principles, and DOC 43, Hygienic Design of Belt Conveyors for the Food Industry.

The object of the present invention is to overcome or at least diminish said hygiene issues.

A further object of the present invention is to provide a sprocket wheel; a food handling facility helical belt conveyor sprocket drive; and a food handling facility edge driven helical belt conveyor that are able to fulfil the requirements of applicable 3-A Sanitary Standards (US) and/or applicable EHEDG guidelines (EU), such as DOC 8, Hygienic Design Principles, and DOC 43, Hygienic Design of Belt Conveyors for the Food Industry.

This is, under a first aspect of the invention, obtained by a sprocket wheel for driving an edge driven helical belt conveyor in a food handling, facility such as a freezing facility, comprising at least one integral body with a curved wheel rim part, said curved wheel rim part comprising at least two parallel rows of teeth; and a hub for carrying the integral body and for providing for attachment to a shaft.

The present inventors have realized that cracks, crevice, or joints between parts of an assembled sprocket wheel may open and close when the sprocket wheel is in operation due to subjection to forces which warps the material and opens the cracks as well as due to changes of temperature, such as in a freezing facility displaying a change of temperature between a low operation temperature during operation and higher temperature during standstill and cleaning. By such opening and closing of cracks, etc. debris and deposits adjacent a crack may be caught in the crack to be difficult or impossible to remove by ordinary, though thorough, cleaning.

By the present invention is obtained that the curved wheel rim part, including the two parallel rows of teeth and an intermediate, circumferential surface between the two rows of teeth present a coherent circumferential surface of the integral body void of any circumferential cracks, crevices, or joints, that might catch e.g. debris during use, whereby hygiene is enhanced.

Especially, a circumferential surface of the sprocket wheel extending from one side face of the sprocket wheel, axially across a first row of teeth, radially inwardly along an inner side surface of said first row of teeth, axially across an intermediate piece, radially outwardly along an inner side face of a second row of teeth, and axially across the second row of teeth to a second side face of the sprocket wheel opposite the first side face, will be void of cracks, crevices and joints between different elements assembled to complete the sprocket wheel, as it is known in the prior art. Thereby it is avoided that debris or deposits may be caught in such cracks, etc. facilitating thorough cleaning to the above mentioned standards for food handling facilities.

The sprocket wheel according to the invention, and especially according to claim 1, may be present in an assembled state as well as an unassembled state. The sprocket wheel will e.g. be in the assembled state during use for driving a belt conveyor and it will typically during transport be in the unassembled state to be assembled when being mounted on a drive shaft.

The present invention includes two parallel rows of teeth in an integral body entails a further benefit, namely that the mutual positions of the teeth of the two rows are fixed whereby it is avoided that the mutual positions of the teeth of the two rows may be shifted relative to intended mutual positions, e.g. aligned in side-by-side position. Hereby is obtained that excess wear of the sprocket teeth due to the teeth of one row being leading relative to the teeth of the other row and thereby being heavier loaded, is avoided.

By providing two parallel rows of teeth is in general obtained that the two rows of teeth may engage with protrusions of a belt conveyor on either side of further protrusions to provide for constraining the belt from undesired movement perpendicular to the rows of teeth.

It should be understood that the curved wheel rim part may be circumferentially continuous, or it may have one or more gaps between neighbouring teeth in one or both rows of teeth.

In a practical embodiment the integral body is monolithic.

In an embodiment the sprocket wheel comprises more of said integral bodies each forming a sector of a rim of the sprocket wheel, the curved wheel rim parts of the integral bodies together constituting the rim of the sprocket wheel. Hereby is provided for convenient assembling at least the rim part of a sprocket wheel around e.g. a shaft.

It should be mentioned that sprocket wheels of the kind mentioned by way of introduction are usually made of a number of components that are assembled to complete the sprocket wheel. E.g. WO 2018/154430 A1 (Tecno Pool S.P.A.) shows a sprocket wheel divided diagonally along a winding track into two components fitting closely together.

In an embodiment the sprocket wheel comprises exactly two integral bodies. Hereby the number of parts of a sprocket wheel to be assembled is kept low, namely the number of parts of the sprocket wheel may be three, excluding fastening means, such as screws bolts and key(s) for mounting the hub on a shaft and interconnecting the three parts including the hub and two integral bodies.

In an embodiment the integral bodies opposite their respective curved wheel rim part comprises an inner surface and a recess or groove provided in said inner surface for accommodating a hub rim part of the hub. Hereby the number of parts of a sprocket wheel to be assembled is kept low.

In a further embodiment said recess or groove is positioned centrally in the inner surface. This provides for ease of assembly and the possibility of reversing e.g. an integral body with worn teeth

In an embodiment, in an assembled condition for use, at least one gap is extending from the curved rim to the inner surface is provided between respective adjacent integral bodies. Hereby a risk of debris getting caught between adjacent integral bodies is minimized.

In a further embodiment a width of the gap, throughout the gap, is sufficient to prevent water from clinging to the surfaces of the integral bodies facing the gap due to capillary forces. Hereby swift drying in case of washing a drive including the sprocket wheel is provided for.

In an embodiment the hub is adapted for direct fastening to a shaft. Hereby the number of parts of a sprocket wheel to be assembled is kept low.

In an embodiment the hub is formed as a flat disk with two large opposite plane surfaces. This provides for a simple construction.

In an embodiment the hub is formed as a disk with a flat hub rim part and a central elevation on at least one side. This may provide additional strength to the sprocket wheel. The elevation may extend, at least in part, to a level of an outer side face of the sprocket wheel thus filling a space in the side at the center of the sprocket wheel.

Under a second aspect of the invention the object is obtained in that a sprocket wheel for driving an edge driven helical belt conveyor in a freezing facility, said helical belt conveyor comprising a belt with an outer lateral side and protrusions extending laterally with a belt side pitch from the outer side, said protrusions each having a driven surface extending at right angles relative to a direction of travel of the belt, said sprocket wheel having an axis of rotation and comprising of two rows of teeth along a circumference of the sprocket wheel, the at least one row of teeth comprising a number of teeth, each tooth having a curved driving surface intended for driving engagement with the driven surfaces of the protrusions of the helical belt conveyor, a radial line extending from the axis of rotation in a plane perpendicular to the axis of rotation, said radial line being tangent to said curved driving surface at a tangential point at a first radial distance from the axis of rotation, the tangential points of the teeth being positioned on a circle around the axis of rotation at a mutual distance between neighbouring teeth defining a sprocket wheel pitch, the curved driving surface having a radius of curvature which is in at least one of the ranges: 5% to 9% of the first radial distance and 13% to 25% of the sprocket wheel pitch. Hereby is obtained a larger distance between a belt engagement point and a belt disengagement point on the sprocket tooth, whereby an enlarged face area of engagement between the sprocket tooth and the protrusion of the belt spreads out a wear area on the teeth of the sprocket wheel. This minimizes wear and results in less debris, thus, enhancing hygiene. Further, prolonging the service life of the sprocket wheel is obtained. Also, the relatively large distance between belt engagement and disengagement points on sprocket tooth combined with tooth geometry lessens impact force as trailing tooth begins to drive belt.

In an embodiment the radius of curvature is constant over the extent of the curved driving surface. In use, each tooth will in turn engage with the protrusions of the belt conveyor whereby an engagement point on the curved driving surface of the tooth will initially engage with the driven surface of a protrusion whereafter the surface of the tooth will slide over the surface of the protrusion until a disengagement point on the curved driving surface of the tooth is reached and the tooth disengages from the protrusion because the next tooth has come into engagement with the driven surface of the next protrusion and so to say takes over driving forward the belt conveyor. The curved driving surface, or at least an effective part thereof, and its extent is thus in practical use defined by the engagement point and the disengagement point.

In a further embodiment the curved driving surface extends a circle segment with the radius of curvature having a center of curvature at a second radial distance from the axis of rotation. The second radial distance may be equal to the first radial distance or it may, depending on the actual shape of the tooth, be slightly smaller, e.g. up to 2% or up to 1% smaller.

In an embodiment the radius of curvature is larger than 5.75%, preferably larger than 6% of the first radial distance.

In a further embodiment the radius of curvature is less than 8%, preferably less than 7% of the first radial distance.

In an embodiment the radius of curvature is in the range of 15% to 21% of the sprocket wheel pitch.

In an embodiment the number of teeth in each row is of an even number, preferably at least 14 and preferably in the range of 14 to 22, especially in the range of 16 to 20. This provides for producing one kind of integral bodies when two integral bodies are used for one sprocket wheel thereby facilitating rational production. Avoiding a very low number of teeth provides a longer service life of the sprocket wheel because each tooth is in engagement with a protrusion fewer times per hour or per traveling length of the belt conveyor when more teeth are provided along the circumference of the sprocket wheel.

The object is further obtained in that a food handling facility helical belt conveyor sprocket drive, such as for a freezing facility, comprises a drive shaft, a motor for rotating the drive shaft, and a plurality of sprocket wheels according to the invention mounted on the drive shaft to rotate therewith. In an embodiment the axes of rotation of the sprocket wheels are coaxial with an axis of the shaft.

The object is further obtained in that a food handling facility edge driven helical belt conveyor comprises at least one food handling helical belt conveyor sprocket drive according to the invention.

### BRIEF DESCRIPTION OF DRAWINGS

In the following the aspects of the invention will be explained in further detail by means of examples of embodiments having reference to the accompanying schematic drawing in which

FIG. 1 shows a helical conveyor in which sprocket wheels according to the present invention may be applied;

FIG. 2 shows sprocket wheels according to the present invention on a shaft;

FIG. 3 shows an exploded view of a sprocket wheel according to the invention;

FIG. 4 shows the sprocket wheel of FIG. 3 in an assembled condition;

FIG. 5 illustrates variations of the sprocket wheel;

FIG. 6 shows an embodiment of a hub of a sprocket wheel;

FIG. 7 shows another embodiment of the hub;

FIG. 8 is a plan view of a sprocket wheel of the invention;

FIG. 9 illustrates the sprocket wheel in engagement with the edge of an edge driven helical belt conveyor; and

FIG. 10 shows in more detail a tooth of the sprocket wheel according to the invention.

### DETAILED DESCRIPTION OF THE DRAWINGS

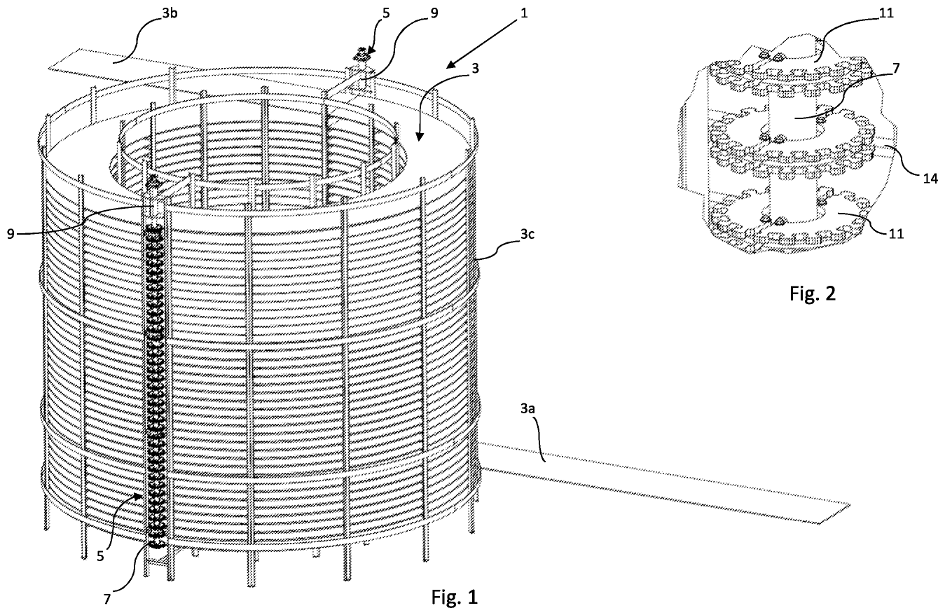

FIG. 1 shows an edge driven helical belt conveyor 1 of a kind generally known per se in the art. Such conveyors are used in freezing facilities for storing and/or processing e.g. food. The conveyor 1 comprises a belt 3 having different runs including an entrance part 3a; an exit part 3b; and helical part 3c in which the belt follows a helical path through a large number of turns from the entrance part 3a to the exit part 3b. From the exit part 3b the belt 3 runs through a course not shown back to the entrance part 3a in this setup of the conveyor belt, as will be familiar to the person skilled in the art. The course not shown may, like in some known constellations, comprise more than one helical conveyor part and may be provided as a set-up in which a returning belt part is interlaced between advancing belt parts.

The belt of the conveyor 1 is in the embodiment shown, driven by means of two sprocket drives 5 positioned on either side of the helical part 3c on the outside thereof as shown. In a manner known per se, each sprocket drive 5 comprises a generally vertical shaft 7 and a motor 9 for rotating the shaft 7. The invention is not limited to a special number of such sprocket drives, in certain embodiments a single sprocket drive may suffice and in other sprocket drives more than two sprocket drives may be used for driving the entire helical conveyor system.

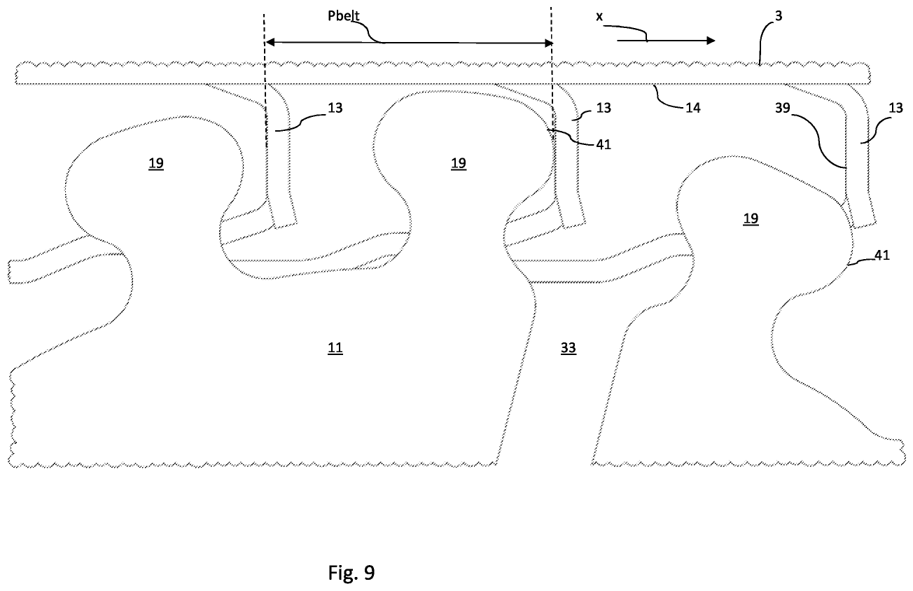

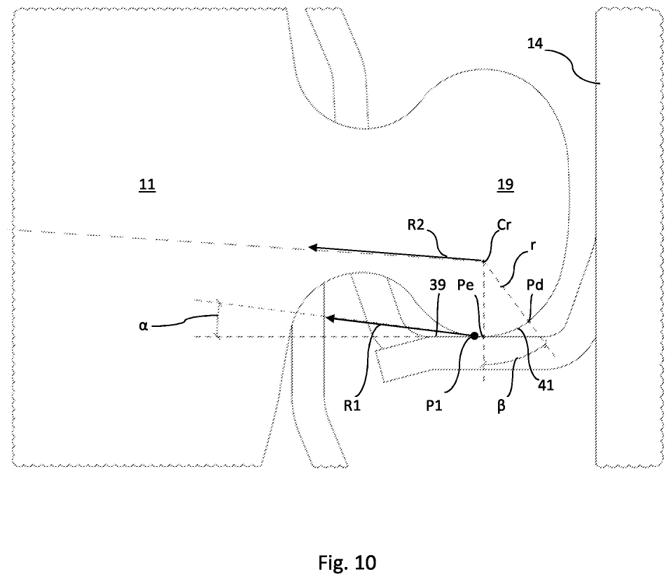

The shafts 7 carries sprocket wheels 11 whereby a sprocket wheel 11 is positioned to engage with protrusions 13 (see FIGS. 9 and 10) extending laterally at an outer side 14 of the belt 3, or generally speaking: on the edge of the belt, at each turn thereof in the helical part 3c. Adjacent sprocket wheels 11 mounted on the shaft 7 are shown in FIG. 2 for the sprocket wheels to rotate in generally horizontal planes.

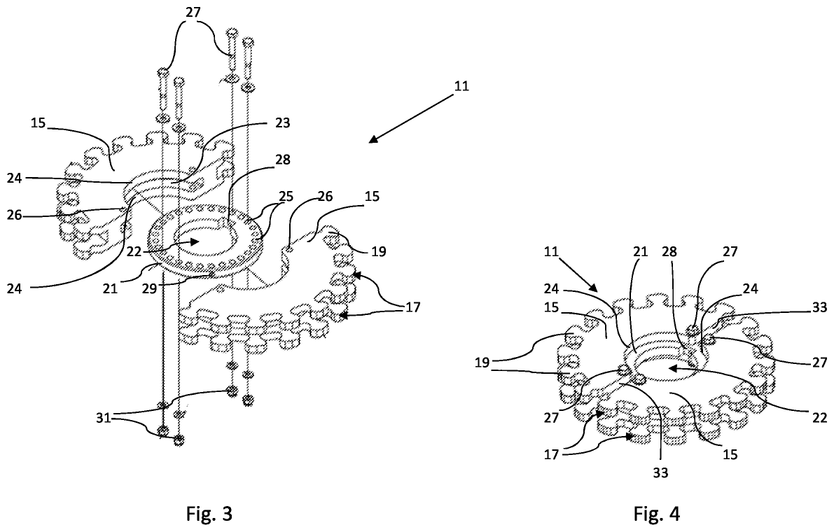

In an embodiment of the present invention the sprocket wheels 11 are constructed as shown FIGS. 3 and 4.

Thus, in the embodiment shown in FIGS. 3 and 4 the sprocket wheel 11 comprises two integral bodies 15 each having a curved wheel rim part, said curved wheel rim part comprising two parallel rows 17 of teeth 19. The sprocket wheel further comprises a hub 21 for carrying the integral bodies 15 and for providing for attachment to the shaft 7. Thus, the hub 21 comprises a central hole 22 for the hub 21 to be threaded onto a shaft 7 by the shaft being inserted through the hole 22.

In the embodiment shown the integral bodies 15 are monolithic.

Each integral body 15 forms a sector, in the present embodiment a semi-circular part, of the rim of the sprocket wheel 15, and the curved wheel rim parts of the integral bodies 15 constitutes together the entire rim of the sprocket wheel 15.

In an inner surface 24 opposite their respective curved wheel rim part, the integral bodies 15 each comprises a recess or groove 23 for accommodating a hub rim part of the hub 21. The recess or groove 23 is positioned centrally in the inner surface 24.

The hub rim part comprises through holes 25 for receiving screws 27 during assembly and likewise the integral bodies comprises through holes 26 for receiving the screws 27 during assembly.

In the present embodiment, the hub 21 is adapted for direct fastening to the shaft 7. Thus, the hub 21 comprises a key way 28 for securing the hub 21 against rotation about the shaft 7 by insertion of a key (not shown) in a key seat in the shaft and in the key way 28. Further, the hub 21 comprises threaded holes 29 for insertion e.g. of headless screws to be tightened against the shaft 7 and lock the hub 21 by friction against axial displacement along the shaft.

For mounting the sprocket wheel 11, the hub 21 is initially threaded onto the shaft 7 and is locked in the intended position by means of a key as mentioned above and one or more likewise mentioned headless screws. Subsequently, the two integral bodies 15 are mounted on the hub 21 by means of four screws 27 preferably provided with washers, said screws being inserted through holes in the respective integral body 15 and appropriate ones of the holes 25 in the hub rim part for the teeth 19 of the sprocket wheel 11 to be placed in appropriate angular positions around the shaft 7. The screws 27 are secured by nuts 31, preferably with washers between the nuts 31 and the integral bodies (as shown).

In the assembled condition, shown in FIG. 4, a gap 33 is extending between the two integral bodies 15 from the curved rim to the inner surface 24. The gap 33 is sufficiently wide to prevent water from clinging by capillary forces to the surfaces of the integral bodies facing the gap 33.

By providing the part of the sprocket wheel carrying the teeth 19, i.e. the integral bodies 15, as integral bodies, especially monolithic, with two rows of teeth, is obtained that circumferential cracks or joints, that might catch e.g. debris during use, are widely avoided whereby hygiene is enhanced compared to known sprocket wheels. Especially such joints or cracks that might be present between the rows of teeth at the circumference of the sprocket wheel are avoided. The two adjacent and parallel rows 17 of teeth 19 provide for running the two rows on either side of elements at the edge of the helical belt conveyor thereby constraining the belt relative to the sprocket wheel from undesired movement in a vertical direction as seen in FIG. 1.

The embodiment shown of the sprocket wheel 11 further provides for convenient assembly, i.a. in that mounting of the hub 21 does not require further elements apart from the key and the headless screw(s), and in that only two integral bodies, that in the embodiment shown are mutually identical, need to be mounted on the hub 21. Thus, the overall number of parts to be assembled to complete the sprocket wheel is kept to a minimum reducing costs of production and storing as well as mounting.

By providing the integral bodies 15 as identical and moreover as symmetrical relative to a centre plane through the recess or groove 23 and between the rows 17 of teeth, the integral bodies 15 may be reversed in case of teeth 19 being worn thus enhancing the overall service life of each integral body 15.

By providing the gab 33 between the integral bodies 15 water and residual debris is widely prevented from clinging to the surface of the sprocket wheel e.g. during and after cleaning whereby hygiene is improved.

FIGS. 5 to 7 illustrate a number of different variations of the sprocket wheel 11.

Thus, FIG. 5 shows different sizes of the integral bodies 15 with different number of teeth 19 in each row. In (a) the total number of teeth is 20, in (b) the total number of teeth is 18, like in the embodiment shown in FIGS. 3 and 4, and in (c) the number of teeth is 16. It is noted that by providing an even number of teeth it is possible to make the two integral bodies 15 identical and maintain the gab 33 between the integral bodies in the assembled condition. Other numbers of teeth, then the numbers mentioned above, are possible.

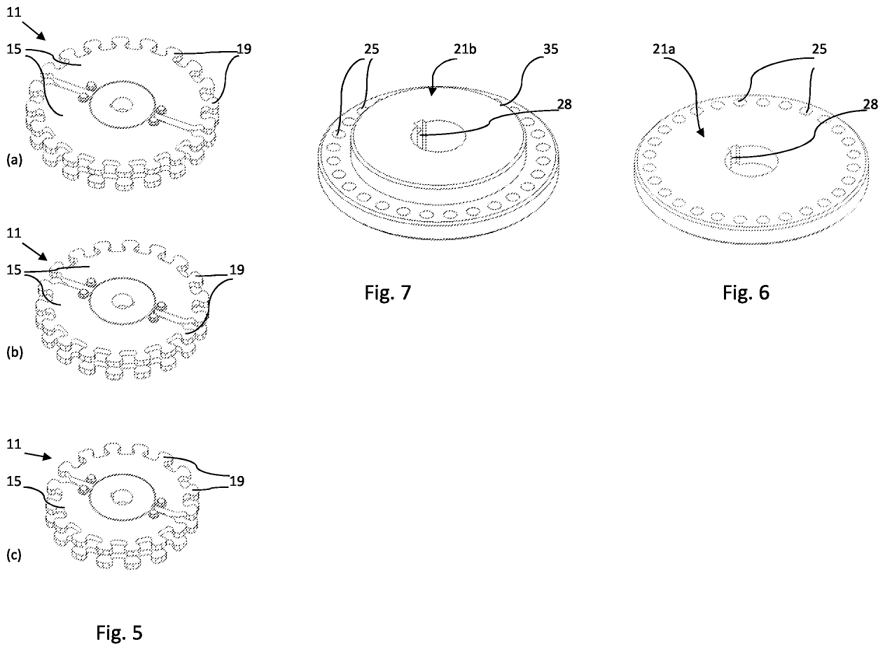

FIG. 6 shows a hub 21a in the form of a flat disk like the hub 21 shown in FIGS. 3 and 4, only the hub 21a is adapted to a shaft with a relatively smaller diameter than the hub 21 and accordingly the central hole 22 is smaller relative to the diameter of the hub.

FIG. 7 shows a variant to the hub 21a in FIG. 6 whereby a central elevation 35 is present on the side of the hub 21b. Such elevation may be present on both sides or on one side only. The elevation 35 provides for enhanced strength and stability of the sprocket wheel in its mounted condition.

The material of the integral bodies 15 and the hub 21, 21a, 21b should be chosen having in mind that the sprocket wheel should be able to work in freezing conditions e.g. below −15° C. or below −20° C. or even down to −40° C. The dimensions of the sprocket wheel 11, including the distance between the parallel rows 17 of teeth, the sprocket wheel pitch Ps-w, etc., should adapted to the belt 3 intended to be driven by means of the sprocket wheel 11. As mentioned above the two rows of teeth may engage with protrusions of a belt conveyor on either side of further protrusions to provide for constraining the belt from undesired vertical movement. It should be understood that relating to the dimensions of the sprocket wheel, the distance between the two rows of teeth should be adapted to the belt with which the sprocket wheel is intended to be used such that the further protrusions of the belt are received with a small play between the two rows of teeth to avoid unnecessary friction on one hand, and on the other hand adequately constrain the belt from undesired vertical movement. The material for the integral bodies 15 could e.g. be any suitable sort of plastics material, etc. In an embodiment the material of the integral bodies 15 has a bright color such as blue, green, orange, etc. in order to make any worn off debris clearly visible. In an embodiment the material of the integral bodies 15 is suitable for engagement with the protrusions of the conveyor belt without application of grease. The material of the hub 21, 21a, 21b should be sufficient strong to transfer the driving forces from the shaft to the integral bodies such as plastics material, possibly reinforced, metal, steel, etc.

Though screws 27 and nuts 31 are shown for fastening the integral bodies on the hub, the integral bodies 15 may be fastened on the hub 21, 21a, 21b by any suitable means.

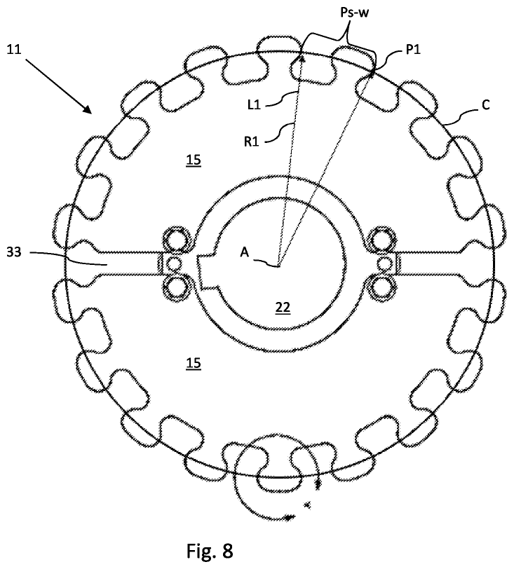

The invention also provides a new shape of the teeth i.e. of the part of the teeth that engages with the protrusions 13 of the conveyor belt. This is illustrated in FIGS. 8 to 10. Thus, FIG. 8 shows a plan view of the sprocket wheel 11 of FIGS. 1 to 4 perpendicular to the axis A of rotation, FIG. 9 shows a detail of the sprocket wheel 11 in engagement with the protrusions 13 on the edge of the belt 3, and FIG. 10 shows an enlargement of the engagement between a single one of the teeth 19 and one of the projections 13.

Thus, the belt 3 of the edge driven helical belt conveyor 1 comprises an edge or lateral side 14 with the protrusions 13 extending with a belt side pitch Pbelt from the edge 14. The protrusions 13 each has a driven surface 39 extending at right angles relative to a direction x of travel of the belt 3. The sprocket wheel 11 has an axis of rotation A parallel to the shaft 7 (see FIG. 2). The teeth 19 of the sprocket wheel 11 each has a curved driving surface 41 intended for driving engagement with the driven surfaces 39 of the protrusions 13 of the belt conveyor 1. A radial line L1 extending from the axis A of rotation in a plane perpendicular to the axis A of rotation, said radial line L1 being tangent to said driving surface 41 at a tangential point P1 at a first radial distance R1 from the axis A of rotation. The tangential points P1 of the teeth 19 are positioned on a circle C around the axis of rotation A at a mutual distance between neighbouring teeth defining a sprocket wheel pitch Ps-w, the curved driving surface 41 having a radius of curvature r (see FIG. 10) which is in at least one of the ranges: 5% to 9% of the first radial distance R1 and 13% to 25% of the sprocket wheel pitch Ps-w. Hereby is obtained an enlarged distance between a belt engagement point Pe and a belt disengagement point Pd on the sprocket tooth 19, whereby an enlarged surface area of engagement between the sprocket tooth and the protrusion of the belt spreads out a wear area on the teeth of the sprocket wheel.

In the present embodiment the radius of curvature r is constant over the extent of the curved driving surface 41, and in the present embodiment the curved driving surface extends a circle segment with the radius of curvature r having a centre of curvature Cr at a second radial distance R2 from the axis of rotation.

The radius of curvature r is in the present embodiment larger than 5.75% and larger than 6% of the first radial distance R1 and the radius of curvature is less than 8% and less than 7% of the first radial distance R1. Further, in the present embodiment, the radius of curvature r is in the range of 15% to 21% of the sprocket wheel pitch Ps-w. More specifically, in the present embodiment the radius of curvature r is approx. 6.25% of the first radial distance R1 and approx. 18% of the pitch Ps-w.

In use, each tooth 19 will in turns engage with the protrusions 13 of the belt conveyor 1 whereby the belt engagement point Pe on the curved driving surface 41 of the tooth will initially engage with the driven surface 39 of the protrusion 13 whereafter the curved driving surface 41 of the tooth 19 will slide over the driven surface 39 of the protrusion 13 until the disengagement point Pd on the curved driving surface 41 of the tooth 19 is reached and the tooth 19 disengages form the protrusion 13 because the next tooth 19 has come into engagement with the next protrusion 13 and so to say takes over driving forward the belt conveyor 1. The curved driving surface 41, or at least an effective part thereof, and its extent is thus in practical use defined by the engagement point Pe and the disengagement point Pd.

FIG. 10 shows the tooth 19 at the moment of engagement between engagement point Pe of the curved driving surface 41 and the driven surface 39. It is noted that in the embodiment shown this engagement takes place when the sprocket wheel 11 has turned an angle α beyond a point where the tangential point P1 would have engaged the driven surface 39. Accordingly, in the present embodiment, the tangential point P1 is positioned outside the effective part of the curved driving surface defined by engagement point Pe and disengagement point Pd and spanning an angle β as indicated in FIG. 10

The second radial distance R2 may be, and is in the present embodiment, equal to the first radial distance R1 or it may, depending on the actual shape of the tooth, be slightly smaller, e.g. up to 2% or up to 1% smaller.

By providing in accordance with the present invention the teeth 19 with a relatively large radius of curvature r of the curved driving surface 41, a relatively large extent of the effective part of the curved driving surface 41 is obtained. This minimizes wear and results in less debris, thus, enhancing hygiene. Further, a prolongation the service life of the sprocket wheel is obtained compared to known sprocket wheels.

Although hereinabove the invention has been illustrated by means of examples it should be understood that these examples are not intended to limit the scope of the invention which is defined by the following claims.

What is claimed is:

1-21. (canceled)

22. A sprocket wheel for driving an edge driven helical belt conveyor in a food handling facility, such as a freezing facility, comprising at least one integral body with a curved wheel rim part, said curved wheel rim part comprising at least two parallel rows of teeth; and a hub for carrying the integral body and for providing for attachment to a shaft.

23. The sprocket wheel according to claim 22, wherein the integral body is monolithic.

24. The sprocket wheel according to claim 22, comprising more of said integral bodies each forming a sector of the curved rim part of the sprocket wheel, the curved wheel rim parts of the integral bodies together constituting the rim of the sprocket wheel.

25. The sprocket wheel according to claim 22, comprising exactly two integral bodies.

26. The sprocket wheel according to claim 22, wherein the integral body or integral bodies opposite its or their respective curved wheel rim part comprises an inner surface and a recess provided in said inner surface for accommodating a hub rim part of the hub.

27. The sprocket wheel according to claim 26, wherein said recess is positioned centrally in the inner surface.

28. The sprocket wheel according to claim 22, wherein, in an assembled condition for use, at least one gap extending from the curved rim to the inner surface is provided between respective adjacent integral bodies.

29. The sprocket wheel according to claim 28, wherein a width of the gap, throughout the gap, is sufficient to prevent water from clinging to the surfaces of the integral bodies facing the gap due to capillary forces.

30. The sprocket wheel according to claim 22, wherein the hub is adapted for direct fastening to a drive shaft.

31. The sprocket wheel according to claim 22, wherein the hub is formed as a flat disk with two large opposite plane surfaces.

32. The sprocket wheel according to claim 22, wherein the hub is formed as a disk with a flat hub rim part and a central elevation on at least one side.

33. The sprocket wheel according to claim 22 for driving an edge driven helical belt conveyor in a freezing facility, said helical belt conveyor comprising a belt with an outer lateral side and protrusions extending laterally with a belt side pitch from the outer side, said protrusions each having a driven surface extending at right angles relative to a direction of travel of the belt, said sprocket wheel having an axis of rotation and comprising of two rows of teeth along a circumference of the sprocket wheel, each tooth having a curved driving surface intended for driving engagement with the driven surfaces of the protrusions of the helical belt conveyor, a radial line extending from the axis of rotation in a plane perpendicular to the axis of rotation, said radial line being tangent to said curved driving surface at a tangential point at a first radial distance from the axis of rotation, the tangential points of the teeth being positioned on a circle around the axis of rotation at a mutual distance between neighboring teeth defining a sprocket wheel pitch, the curved driving surface having a radius of curvature which is in at least one of the ranges: 5% to 9% of the first radial distance and 13% to 25% of the sprocket wheel pitch.

34. The sprocket wheel according to claim 33, wherein said radius of curvature is constant over the extent of the curved driving surface.

35. The sprocket wheel according to claim 33, wherein the curved driving surface extends a circle segment with the radius of curvature having a center of curvature at a second radial distance from the axis of rotation.

36. The sprocket wheel according to claim 33, wherein said radius of curvature is one of 5.75% and 6% larger than the first radial distance.

37. The sprocket wheel according to claim 33, wherein the radius of curvature is one of 8% and 7% less than the first radial distance.

38. The A sprocket wheel according to claim 33, wherein the radius of curvature is in the range of 15% to 21% of the sprocket wheel pitch.

39. The sprocket wheel according to claim 22 wherein the number of teeth in each row of the sprocket wheel is at least one of an: even number; at least 14; in the range of 14 to 22; and in the range of 16 to 20.

40. A food handling facility helical belt conveyor sprocket drive, such as for a freezing facility, comprising a drive shaft, a motor for rotating the drive shaft, and a plurality of sprocket wheels according to claim 22 mounted on the drive shaft to rotate therewith.

41. The food handling facility helical belt conveyor sprocket drive according to claim 40, wherein the axes of rotation of the sprocket wheels are coaxial with an axis of the shaft.

42. A food handling facility edge driven helical belt conveyor comprising at least one food handling facility helical belt conveyor sprocket drive according to claim 40.
